(19) United States
(12) Patent Application Publication
(10) Pub. No.: US 2024/0039116 A1
(43) Pub. Date: Feb. 1, 2024

(54) Method of Printing and Articles

(71) Applicant: QinetiQ Limited, Farnborough, Hampshire (GB)

(72) Inventors: Max William Angus REID, Chelmsford, Essex (GB); Charles John Michael FOOTER, Farnborough, Hampshire (GB)

(21) Appl. No.: 18/265,929

(22) PCT Filed: Nov. 29, 2021
(86) PCT No.: PCT/EP2021/083389

§ 371 Date: Jun. 7, 2023

(30) Foreign Application Priority Data
Dec. 11, 2020 (GB) 2019615.0

(51) Int. Cl. H01M 50/403; H01M 10/04

(52) U.S. Cl. CPC H01M 50/403; H01M 10/0431

(57) ABSTRACT

Method of printing and articles A method of printing a separator for an electrochemical cell and articles made therefrom. A method of printing a separator for an electrochemical cell and a method of printing an electrochemical cell comprises providing an ink having particles of a separator-forming substance suspended within it and printing a layer of the ink onto a surface. The separator is formed from the separator-forming substance in the layer of ink. This may be done by drying or curing the layer of ink. The separa-tor-forming particles may host an electrolyte before or after the separator is formed.

The invention relates to a method of printing a separator for an electrochemical cell and articles made therefrom.

### BACKGROUND

Modern life has come to depend on all kinds of consumer electrochemical cells: from batteries to fuel cells, supercapacitors and beyond. The applications of these cells have evolved over the decades to meet the needs of developing technologies.

Today, consumer electrochemical cells are needed to support all kinds of portable and isolated electronics including mobile telephones, smart cards, wearable devices, and high-throughput electronics. To assist with some of these applications, thin film electrochemical cells have been developed, which, due to their compact arrangement, can be arranged within these devices with ease.

Electrochemical cells comprise a positive electrode, a negative electrode, and an electrolyte arranged therebetween. To prevent internal short circuiting, a separator is commonly used to provide a physical barrier between the two electrodes. This is particularly important for thin film electrochemical cells, where due to the close arrangement of the electrodes, internal short circuiting is more likely. The separator is configured to allow ions in the electrolyte to move through it so that electrical current can flow between the electrodes.

Manufacture of thin film electrochemical cells, and in particular manufacture of separators for such cells is difficult. As a result, cost-effective and time efficient mass production of such cells has not been possible. Amongst other issues, arranging components, particularly thin films, in position to form a cell and then applying the cell with electrolyte can be complicated and time-intensive.

Attempts have been made to print separators using polymer gel inks. However, due to the relatively weak structure of the polymer, it has not been possible to print polymer separators as thinly as desired. This is because when such polymer separators are thin, dendritic growth on the electrodes (e.g. lithium deposits that build up on anodes) are able to puncture the relatively weak separator thereby causing a short circuit.

The method according to the present invention aim to solve or at least alleviate one or more of the problems associated with the prior art.

### SUMMARY OF THE INVENTION

The present invention provides a method of printing a separator for an electrochemical cell, the method comprising:
providing an ink comprising particles of a separator-forming substance suspended therein,
providing a medium,
applying a layer of the ink to the medium in a printing process, and
forming a separator from the separator-forming substance in the layer of ink.

The method of the invention is advantageous as it can be used to print separators for all varieties of electrochemical cell, but especially thin and flexible separators for use in thin and flexible film electrochemical cells, for example those below 1000 microns in thickness. By making use of a printing process, this method can print separators for electrochemical cells both easily and quickly. The printed separators formed by the method are robust and not easily punctured by dendrite growth on one or both of the electrodes.

The medium may, for example, be another component of an electrochemical cell such as one of the electrodes of the electrochemical cell. Alternatively, the medium may be a separate substrate not forming part of the electrochemical cell but rather provided as a carrier surface for the separator during manufacture. The ink may be any substance that can be printed, for example, by a printer head.

The particles of separator-forming substance are discrete particles suspended in the ink in the form of a mixture or a suspension.

Optionally the separator-forming substance forms a separator that hosts at least some of the electrolyte.

By providing an electrolyte in the ink there is no need for an additional step of providing an electrolyte to the electrochemical cell after the separator is formed. Thus, the method is made more efficient and electrochemical cells including such a separator are more easily rapidly produced.

The ink preferably comprises a solvent such that the ink is itself an electrolytic solution. In this case, the electrolyte is dissolved in the solvent and the separator-forming substance is suspended in the solvent.

The step of forming the separator optionally comprises drying or curing the ink.

Drying or curing the ink may comprise applying a laser to the ink or applying heat to the ink. In drying and/or curing the ink, the solvent may be substantially evaporated.

In one example, the separator-forming substance may be an ionic conductor material.

Forming the separator from materials which are able to conduct ions is advantageous as the separator is able to form a relatively dense and robust layer which resists puncture from dendritic growths on the electrode(s) and which allows ion passage through the structure of the separator when the electrochemical cell is connected to a circuit. Separators formed as described are suitable for all kinds of electrochemical cell including fuel cells, lithium ion cells, alkaline cells, and capacitors. Such separators are particularly advantageous in thin film electrochemical cells where dendritic growths may be sufficient to bridge the distance between the electrodes thereby causing a short-circuit.

Optionally the ionic conductor material is a nano-porous material.

For separators made from nano-porous materials, electrolytic ions are able to reside within and move through the porous structure of the material to allow current to pass from one side of the separator to the other.

The nano-porous material may be a zeolite or an organic framework material such as a metal organic framework or a covalent organic framework.

In one example the separator is at least partially impregnated with ions provided from the electrolyte when formed.

Optionally the step of providing an ink comprises the steps of:
providing particles of the nano-porous material, providing the electrolyte, providing a solvent, dissolving the electrolyte in the solvent, and adding the particles of the nano-porous material to the solvent to form the ink.

The particles of the nano-porous material may become impregnated with ions provided from the electrolyte before the layer of ink is printed. It is advantageously efficient for the particles of the nano-porous material to become impregnated with the electrolyte when the ink is formed. In another example, the particles of the nano-porous material may impregnated with ions from the electrolyte, or from another electrolyte, before they are added to the solvent to form the ink. Alternatively or additionally, the particles may be sprayed or printed with an electrolyte after the layer of ink has been printed.

The ink may comprise a second separator-forming substance in the form of polymeric binder, and wherein the separator is formed from the separator-forming substance and the second separator-forming substance.

In one example the step of providing an ink comprises the step of adding polymeric binder to the solvent, wherein the step of forming a separator optionally comprises drying/curing the ink.

The addition of a polymeric binder is advantageous as it may act as an adhesive and hence serve to assist with adherence of the particles of separator-forming material to each other and with the adherence of the formed separator to the medium. The optional curing step may be in addition to or instead of drying the ink. The curing step may assist in, or may be responsible for, formation of the separator.

The ionic conductor material may be a solid ionic conductor, optionally lithium phosphorus oxynitride.

The ionic conductor material may optionally be an inorganic lattice material, preferably a crystalline conductor.

In one example, the inorganic lattice material is a perovskite material or a lithium superionic conductor material.

The perovskite material may be LLTO (LiₓLa_{y}TiO₃). The lithium superionic conductor material may be Li₁₀GeP₂S₁₂ (LGPS). The skilled person appreciates that many other related materials for the inorganic lattice material are suitable such as lithium-stuffed garnet Li₇La₃Zr₂O₁₂ (LLZO).

Optionally the electrolyte comprises the inorganic lattice material.

In inorganic lattice ionic conductor materials electrolytic ions are able to move through vacant sites, known as gaps, the crystalline lattice.

The step of providing an ink may optionally comprise the steps of:
providing particles of the solid ionic conductor,
providing a liquid or a gel, and
adding the particles of the solid ionic conductor to the liquid or gel to form the ink.

In one example the formed separator comprises a close-packed array of the particles of separator-forming substance.

The intrinsically efficient use of space in such close-packed particle arrangements is advantageous as it facilitates greatly reduced separator thickness while still ensuring robust physical separation between the electrodes. The particles may have different morphologies which can fit together in an ordered or un-ordered close-packed array.

Separators comprising a close-packed array of particles are particularly suited to electrochemical cells in which dendritic deposits are likely since the closely-packed array is especially robust to puncture.

When used with an electrochemical cell, the particles of the separator-forming substance(s) are preferably chemically inert with respect to the electrodes and electrolyte thereof.

In one example the particles of separator-forming material comprise a non-ionic conductor material which may comprise silica, preferably in the form of silica nano-particles which are cheap and readily available.

Optionally the step of providing the ink comprises the steps of:
providing particles of the non-ionic conductor material,
providing the electrolyte,
providing a solvent,
dissolving the electrolyte in the solvent to form an electrolytic solution, and
adding the particles of the non-ionic conductor material to the solvent to form the ink.

The particles of separator-forming substance in the formed separator may optionally be at least partially coated with the electrolytic solution.

In this example, the step of forming a separator may comprise drying or curing the ink until the solvent has substantially evaporated from the separator. In one example, the ink is optionally not completely removed from the separator during the drying or curing process so as to leave a coating of electrolytic solution around the particles in the close-packed array of the formed separator to facilitate ion movement through the separator during use in an electrochemical cell.

In another aspect, the present invention provides a method of forming an electrochemical cell comprising:
providing a first electrode;
printing a separator on the first electrode in accordance with the above described method wherein the medium is the first electrode; and
providing a second electrode, wherein the separator is located between the first and second electrodes in the so formed electrochemical cell.

Optionally providing the first electrode comprises printing the first electrode on a substrate; and/or providing the second electrode comprises printing the second electrode on the separator.

Printing both of the electrodes is beneficial as a complete electrochemical cell may be printed onto a single substrate allowing for a fast inexpensive method of electrochemical cell production. In some examples the entire electrochemical cell may be printed using a single printing device. Reel-to-reel printing may be used which negates the need for other equipment which might slow down the production process and reduce consistency. This method may be used to print all kinds of electrochemical cells, but especially thin film electrochemical cells.

Instead of printing, the first and/or second electrodes may be provided and applied using any suitable process. The first and second electrodes may be electrode layers.

The substrate may be an electrically insulating material or a conductive material; a fabric, a polymer, a glass, a paper, a metal, or a ceramic. The substrate may itself comprise a previously printed material, and may include electronic circuits.

Optionally the step of providing the first electrode on the substrate comprises printing a first current collector on the substate and printing the first electrode on the first current collector.

The method may optionally comprise printing a second current collector on the second electrode.

Alternatively, the current collectors can be provided and applied to the electrochemical cell at any suitable point in the manufacturing process using any suitable process. The current collectors serve to maximise current flow for the electrodes.

In a further aspect, the present invention provides a method of forming an electrochemical cell comprising:
providing a first electrode on a first portion of a substrate;
providing a second electrode on a second portion of the substrate, wherein the second portion is separated from the first portion by a third portion of the substrate;
printing a separator over one or both of the first second electrodes in accordance with the above described method wherein the medium is the first and/or second electrode;
and
folding the substrate over itself such that the separator is located between the first and second electrodes.

Optionally providing the first electrode comprises printing the first electrode on the first portion of the substrate; and/or providing the second electrode comprises printing the second electrode on the second portion of the separator.

This method may be used to print all kinds of electrochemical cell, but especially thin film electrochemical cells.

The step of providing the first electrode on the first portion of the substrate may comprise printing a first current collector on the first portion of the substrate and printing the first electrode on the first current collector, and wherein the step of providing the second electrode on a second portion of the substrate comprises printing a second current collector on the second portion of the substrate and printing the second electrode on the second current collector.

Alternatively, the current collectors can be provided and applied to the electrochemical cell using any suitable process.

In one example, the method comprises a step of printing a protective cover on the first current collector, the first electrode, the separator, the second electrode, or the second current collector.

The protective cover is preferably insulating and seals the electrical components of the electrochemical cell while still allowing access to the current collectors and/or the electrodes for electrical connection. The protective cover may be a layer.

In a still further aspect, the present invention provides a method of forming an electrochemical cell comprising:
providing a first electrode;
providing a second electrode;
printing a separator on a substrate in accordance with the method described above of wherein the medium is the substrate;
removing the separator from the substrate; and
arranging the separator between the first and second electrodes.

This method may be used to print all kinds of electrochemical cell, but especially thin film electrochemical cells.

Additionally, the method can include steps of providing first and second current collectors and applying the first and second current collectors to the respective first and second electrodes. This can be done using any suitable process. Alternatively, the first and/or second current collector can be printed on the respective first and second electrodes. Preferably, the method includes a final step of applying a protective cover on each outer side of the current collectors or electrodes.

In another aspect, the present invention provides an article comprising an electrochemical cell comprising a separator prepared according to a method as described above.

In a further aspect, the present invention provides article comprising an electrochemical cell prepared according to a method as described above.

A variety of new technologies and products are made possible according to the invention. Printed devices and thin cells in particular lend themselves to inclusion in articles where accessibility and space is limited or otherwise problematic. Embodiments of the invention can be used in a very wide variety of devices such as devices which are intended to be wearable (e.g. clothing, wristbands, headware, underwear, footwear, gloves), portable (e.g. suitable for use by people and animals), producible on mass scale, printable, disposable, conformable, or low power. Similarly, the invention is suited to devices requiring cost effective circuitry or which involve monitoring, logging, sensing, receiving, and data transmission. Embodiments include devices in or for, for example: mobile phones, smart cards, smart packaging, smart sensors (e.g. smart healthcare), environmental sensing devices (e.g. sensing properties of temperature, gases, humidity and other properties within containers), healthcare sensing, healthcare monitoring, and high throughput electronics devices.

Features of any one aspect or embodiment of the invention may be used, alone or in appropriate combination, with any other aspects and embodiments as may be appropriate.

### BRIEF DESCRIPTION OF THE DRAWINGS

The above and other aspects of the invention will now be described, by way of example only, with reference to the remainder of the accompanying drawings, in which:

FIG. 1 is a cross-sectional schematic of an electrochemical cell;

FIG. 2 is a flow chart indicating the steps of a method of printing a separator for the electrochemical cell of FIG. 1 in accordance with the invention;

FIG. 3 is an exploded view of a separator printed in accordance with the method of FIG. 2;

FIG. 4 is cross-sectional view of a separator printed in accordance with the method of FIG. 2;

FIG. 5 is a flow chart indicating the steps of a method of providing a nano-porous ink for the method of FIG. 2;

FIG. 6 is a flow chart indicating the steps of a method of providing an inorganic lattice material ink for the method of FIG. 2;

FIG. 7 is a flow chart indicating the steps of a method of providing a closely packable material for the method of FIG. 2;

FIG. 8 is a flow chart indicating the steps of a method of printing an electrochemical cell that includes a separator printed in accordance with the method of FIG. 2;

FIG. 9 is an exploded view of an electrochemical cell that has been printed in accordance with the method of FIG. 8;

FIG. 10 is a cross-sectional view of an electrochemical cell printed in accordance with the method of FIG. 8;

FIG. 11 is a cross-sectional view of another electrochemical cell printed in accordance with the method of FIG. 8;

FIG. 12 is a photograph of a negative electrode printed on a separator;

FIG. 13 is a flow chart indicating the steps of another method of printing an electrochemical cell that includes a separator printed in accordance with the method of FIG. 2;

FIG. 14 is an exploded view of an electrochemical cell that has been printed in accordance with the method of FIG. 13;

FIG. 15 is a cross-sectional view of an electrochemical cell printed in accordance with the method of FIG. 13;

FIG. 16 is a cross-sectional view of another electrochemical cell printed in accordance with the method of FIG. 13;

FIG. 17 is a photograph of a further electrochemical cell being printed in accordance with the method of FIG. 13;

FIG. 18 is a photograph of an electrochemical cell that has been printed in accordance with the method of FIG. 8;

FIG. 19 a scanning electron microscope (SEM) image of a separator printed on a cathode;

FIG. 20 is a 1 μA continuous discharge curve of a 5 cm² electrochemical cell that been printed in accordance with the method of FIG. 8;

FIG. 21 is an electrochemical impedance spectra applying a 10 mV AC sinusoidal voltage at frequencies between 10⁵ and 10⁻¹ Hz, for three printed cells containing three electrolytes printed in accordance with the method of FIG. 8.

FIG. 22 is a schematic view of an article of footwear incorporating an electrochemical cell that has been printed in accordance with the method of FIG. 8 or 13;

FIG. 23 is a schematic view of an article of packaging incorporating an electrochemical cell that has been printed in accordance with the method of FIG. 8 or 13;

FIG. 24 is a schematic view of a wristband incorporating an electrochemical cell that has been printed in accordance with the method of FIG. 8 or 13; and

FIG. 25 is a schematic view of an article of clothing incorporating an electrochemical cell that has been printed in accordance with the method of FIG. 8 or 13.

### DETAILED DESCRIPTION

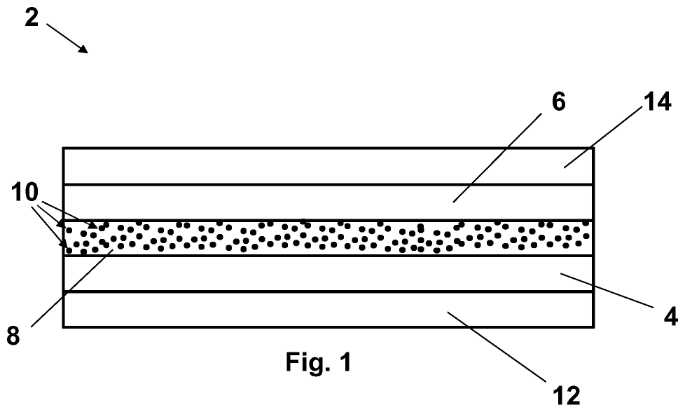

The electrochemical cell 2 of FIG. 1 is configured to provide electrical current to an electrical device (not shown). To this end, the electrochemical cell 2 comprises a first electrode 4 in the form of an anode, i.e. a positive electrode, and a second electrode 6 in the form of a cathode, i.e. a negative electrode. To provide said electrical current, the first and second electrodes 4, 6 of the electrochemical cell 2 are couplable to an electrical device (not shown) in conventional way.

To prevent short circuiting between the first and second electrodes 4, 6, the electrochemical cell 2 is further provided with a separator 8 that is arranged between the first and second electrodes 4, 6. The separator 8 is chemically inert with respect to the electrolyte 10 (described further below) and the first and second electrodes 4, 6. In this way, the first and second electrodes 4, 6 are electrically separated and the likelihood of short circuiting is reduced.

As well as serving a safety device for the electrochemical cell 2, the separator 8 also provides structure for the electrochemical cell 2 and reduces point stresses applied to electrodes. Depending on the application, the separator 8 can be non-toxic and disposable.

To bring about a flow of current between the first and second electrodes 4,6, and hence to power an electrical device (not shown) connected to the electrochemical cell 2, the electrochemical cell 2 comprises an electrolyte 10 which provides electrolytic ions capable of moving between the first and second electrodes 4, 6 to convey electrical current when the electrochemical cell is connected to a circuit. The electrolyte 10 is electrochemically active with respect to both the first and second electrodes 4, 6, and is selected to react with the anode 4 to produce free electrons, and react with the cathode 6 and free electrons, thereby bringing about a flow of current between the two electrodes 4, 6.

The electrolytic ions are maintained within, and yet can move through, the separator 8. In this way, it may be said that the separator 8 “hosts” the electrolytic ions. This may be achieved by the electrolyte 10 being dissolved in a polar solvent to form an electrolytic solution which resides within the separator 8, or may be achieved by ions provided from the electrolyte (in solid or solution form) residing within the body of the separator 8.

The electrochemical cell 2 may also comprise first and second current collectors 12, 14 configured maximise current flow between the two electrodes 4, 6. To this end, the first and second current collectors 12, 14 are arranged in contact with the respective first and second electrodes 4, 6 apart from the separator 8. That is to say, the first current collector 12 is arranged directly adjacent to the first electrode 4 but away from the separator 8, while the second current collector 14 is arranged directly adjacent to the second electrode 6 but away from the separator 8, as shown in FIG. 1. In this embodiment, the first and second current collectors 12, 14 are couplable to an electrical device (not shown).

The electrochemical cell 2 of FIG. 1 is a thin film electrochemical cell 2. In other words, the electrochemical cell 2 has a thickness of less than 1000 microns. To achieve such a thin film, the separator 8, the electrodes 4, 6, and the current collectors 12, 14 all take the form of thin film layers.

Although this disclosure relates to a separator 8 for a thin film electrochemical cell 2, and in particular to a method of printing of such a separator 8, the skilled person will appreciate that the described method is equally suited for printing separators 8 for use in all types of electrochemical cell 2.

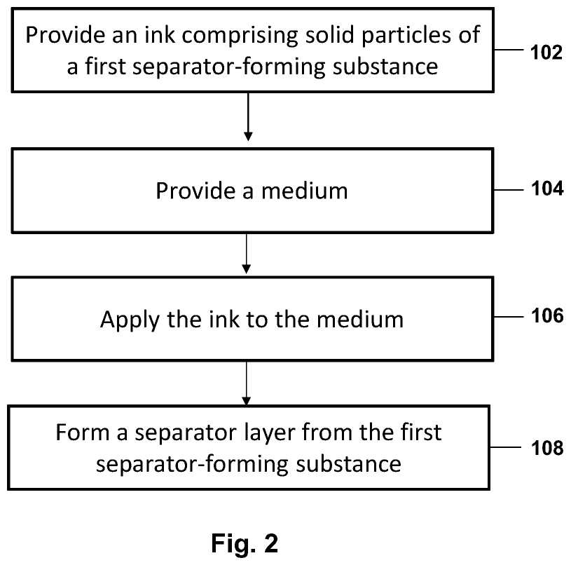

The method for printing the separator 8 is depicted in FIG. 2.

In the first step 102, an ink, i.e. a functional ink, is provided. It is this ink that is printed to form the separator 8. Notably, the ink of the invention comprises discrete particles of a separator-forming substance that are suspended within the ink. The separator-forming substance is not dissolvable in the ink and remains as particles suspended within the ink. The separator 8, once formed, comprises these particles of the separator-forming substance.

In the second step 104, a medium, such as a substrate 20, is provided. It is onto this medium that the separator 8 is printed. The skilled person appreciates that the first and second steps 102, 104 may be carried out in any order.

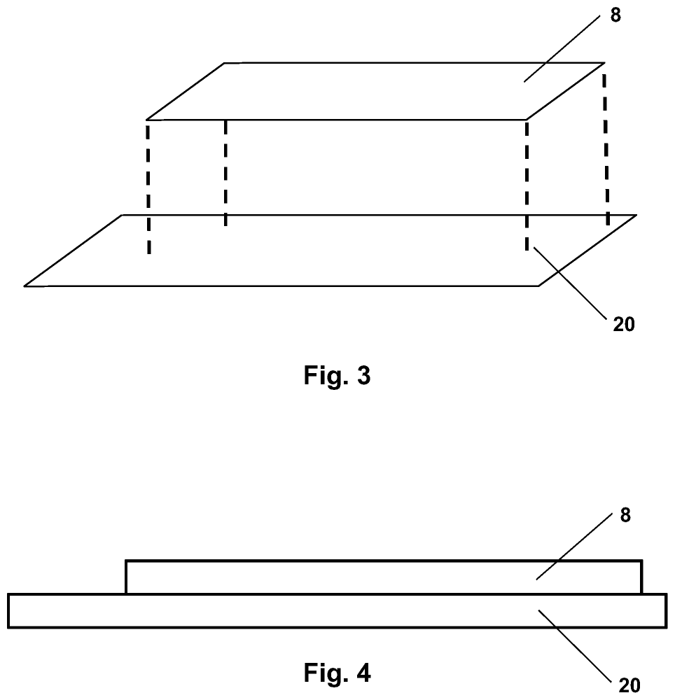

In the next step 106, the ink is applied to the medium, e.g. using a suitable printing process. In the final step 108, the separator 8 is formed on the medium from the particles of the separator-forming substance in the printed ink, as shown in FIGS. 3 and 4.

By using an ink that comprises the aforementioned particles of a separator-forming substance, the method of the invention is able to produce separators 8 that are robust to penetration from dendritic growth and from external articles which might damage the electrochemical cell 2. As such, even when the separator 8 is very thin, it is resilient to being broken or punctured (for example, by dendrites e.g. lithium particles, that may build up on the anode 4).

Moreover, despite this increased toughness, the separator 8 is flexible and conformable and, as such, is suitable for a variety of applications of an electrochemical cell 2, including low power, conformable and disposable applications in wearable technology, smart packaging, and discrete environmental sensing devices, more of which will be described below.

Finally, due to the simplicity of the process, it is possible to manufacture separators 8 quickly and with ease.

Each of the steps of the invention will now be described in more detail.

In the first step 102, the ink comprising particles of the separator-forming substance are provided.

While the ink may take the form of any material that can be printed, for the purposes of this description the ink is a liquid suspension before printing, but is made substantially solid after printing, preferably by a process of drying and/or curing (depending on the type of ink used). The ink may also be a gel prior to printing.

To this end, the ink comprises a liquid or gel base within which the particles of the separator-forming substance are suspended. The skilled person appreciates that the ink may comprise other liquid, gel, polymer or particulate components.

For example, the liquid base may also comprise the solvent for the electrolyte 10. In this way, the separator 8, one printed, already hosts at least some of the electrolytic ions from the electrolyte 10. This beneficially negates the need for any additional step of providing a suitable electrolyte 10 to the separator 8 after it is formed.

Suitable materials for the separator-forming substance include nano-porous materials, ionic conductor materials and particulate materials which are able to form a close-packed structure.

Before detailing each of these materials in turn, it is noteworthy that both the nano-porous material and the ionic conductor material may be referred to as ionic conductor materials. This is because they both allow electrolytic ions to move through their structures. When an ionic conductor material is used for the separator-forming substance, the separator 8 that is formed is therefore also ionically conducting.

When the separators 8 host ions from the electrolyte 10 (described in more detail below), the separator 8 can be described as a solid-state electrolyte. For such separators 8, the chances of short-circuits are substantially reduced compared to when a polymer electrolyte 10 is used. This therefore makes these separators 8 particularly well suited for thin film electrochemical cells 2.

Three different example of suitable materials for the separator-forming substance will now be described in turn, and methods for producing an ink containing the particles of such separator-forming substances will also be outlined.

The first example is that of a nano-porous material, and an ink containing particles of a nano-porous material

Where the particles of separator-forming substance comprise a nano-porous material, the separator 8 formed by such particles is subsequently also nano-porous. For such separators, electrolytic ions from the electrolyte 10 are able to move through the pores of the nano-porous material thereby allowing an electric current to pass through the nano-porous material. Such separators are suitable for many kinds of electrochemical cell including but not limited to a fuel cell, a lithium ion cell, an alkaline cell, and a capacitor.

Suitable nano-porous materials include organic framework material and or zeolites. The skilled person appreciates that many other similar materials are suitable.

Organic framework materials include metal organic frameworks (MOFs), covalent organic frameworks (COFs) and any other material which use organic molecules as ‘building blocks’ to form a regular 1-,2-, or 3-dimensional open structures. In the case of MOFs, a metal ion or a metal cluster is coordinated to an organic ligands to produce a cage network. In the case of COFs, organic molecules arrange into a repeating cage network through strong covalent bonding. The properties of organic framework materials are tuneable depending on the metal ion/cluster/organic molecules used in synthesis. These properties include high surface area, large pore sizes, high species diffusivity, catalytic action, mechanical strength, thermal stability, chemical stability, and electrical insulation. Due to the tuneable nature, electrical insulation, mechanical strength and high diffusivity of species through the structure, organic framework materials are well-suited for separator applications in electrochemical cells. The particles of organic framework material used in the ink are typically less than 10 μm in size.

When the separator-forming material is a nano-porous material, and the ink includes an electrolyte 10, the separator 8 may be formed at least partially impregnated with electrolytic ions from the electrolyte 10. Alternatively, the ink need not comprise an electrolyte 10, in which case the separator 8 may be impregnated with electrolytic ions it is formed.

As an addition to the particulate separator-forming substance, the ink may also comprise a second separator-forming substance in the form of a polymeric binder. For these inks, both the first and second separator-forming substances together form the separator 8. In this example, the second-separator-forming substance serves to assist in adherence of the particles of the separator-forming substance to one another and the adherence of the formed separator 8 to the medium on which it is printed.

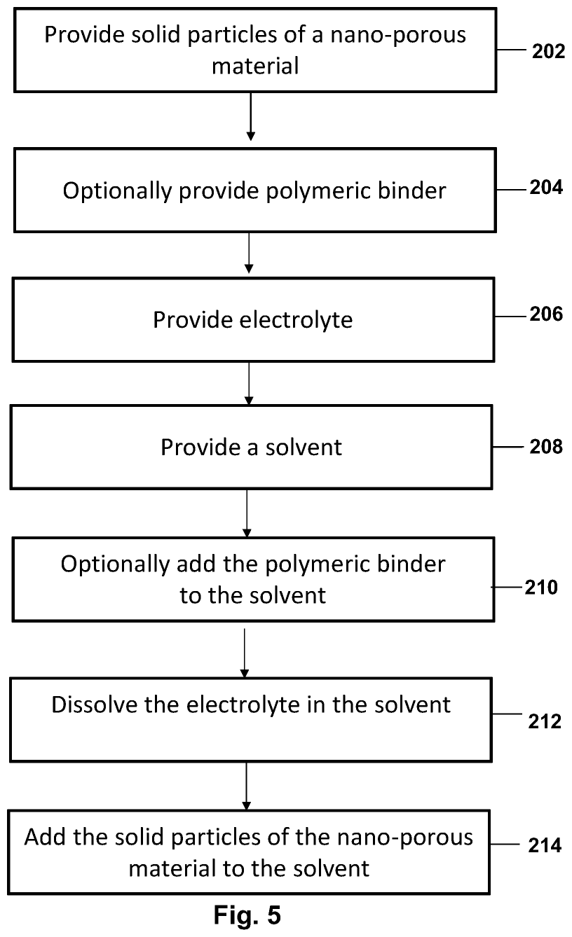

To form, or provide, the above-described nano-porous material inks, the following exemplary steps may be taken, as depicted in FIG. 5.

In the first step 202 the particles of the nano-porous material are provided. In the next step 204 the polymeric binder (if used) is provided. In the following step 206 the electrolyte 10 is provided. In the following step 208 a solvent is provided. The skilled person appreciates however that each of the particles of the nano-porous material, the polymeric binder, the electrolyte 10 and the solvent can be provided in any order.

In step 210 the polymeric binder (if used) is added to, and may be dissolved in, the solvent, then, in the following step 212, the electrolyte 10 is dissolved in the solvent. In the final step 214, solid particles of the nano-porous material are added to the solvent. At this stage, the particles of nano-porous material become impregnated with electrolytic ions from the dissolved electrolyte 10. For this example ink formulation, the liquid base of the ink therefore comprises the solvent, the electrolyte 10 and the polymeric binder (if used).

It will be understood by the person skilled in the art that the separate elements of the ink may be added in any suitable order and that the order given above is by way of example only. For example, the polymeric binder may be added to the solvent after the electrolyte 10 is dissolved in the solvent, or after the particles of nano-porous material are added to the solvent.

As a further alternative, the particles of nano-porous material may be pre-impregnated with electrolytic ions before being added to the ink. In this example it may not be necessary to provide an additional electrolyte 10 dissolved in a solvent and, indeed, the liquid (or gel) portion if the ink may merely provide a suitable carrier for the particles of nano-porous material in suspension. Alternatively or additionally, the particles of nano-porous material may be impregnated with an electrolyte after the layer of ink has been printed either before or after the ink has dried or is cured.

As a second example, an ink comprising particles of an inorganic lattice material will be described.

Where the particles of separator-forming substance comprise an inorganic lattice material, the separator 8 made from an ink comprising such particles takes the form of an inorganic lattice separator 8. The inorganic lattice material is preferably a crystalline solid conductor.

Crystalline solid conductors contain electrolyte as species in the structure, and so need not be impregnated with electrolyte in the same way as the nano-porous material example given above. As such, when the separator 8 is printed from an ink comprising particles of such an inorganic lattice material, it already contains the electrolytic ions required to facilitate a flow of current between the electrodes of an electrochemical cell 2.

Suitable example inorganic lattice materials include perovskite materials such as LLTO (LiₓLa_{y}TiO₃) or a lithium superionic conductor material such as LGPS. The skilled person appreciates that many other related materials for the inorganic lattice material are suitable.

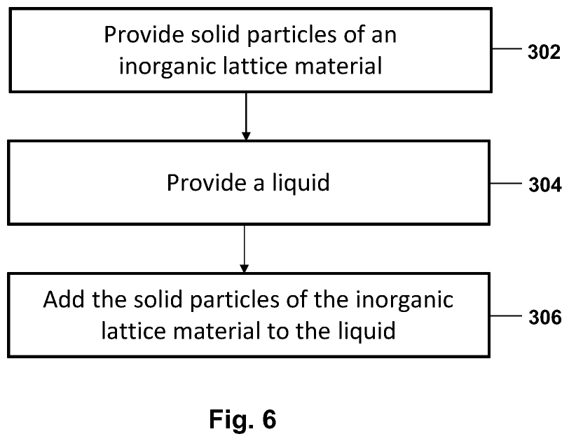

To form, or provide, such an inorganic lattice material ink, the following exemplary steps maybe taken, as depicted in FIG. 6.

In the first step 302 particles of an inorganic lattice material are provided. As discussed above, these particles comprise electrolytic ions such that the formed separator is able to function as the electrolyte 10 in the electrochemical cell 2. In the next step 304 a suitable liquid or gel carrier, such as an organic solvent, is provided. In the final step 306, the particles of the inorganic lattice material are added to the liquid or gel. The skilled person will, appreciate that the above mentioned components of the ink could be provided in any order.

As a third example and ink comprising particles capable of forming a close-packed array will now be described.

The particles of separator-forming substance may have a morphology that allows them to form a close-packed array in the formed separator 8. In one example, when the particles of separator-forming material have such a morphology, and the ink comprises and electrolytic fluid, the separator 8 may be formed particles at least partially coated with some of the electrolytic fluid. Alternatively, the “close-packed” separator 8 may coated with an electrolytic solution after being formed. In this case, the electrolytic solution, or ions from the electrolytic solution, are able to diffuse into the body of the separator by my diffusing around the closely-packed particles. Electrical currents are thereby able to flow through the “close-packed” separator by movement of the electrolytic ions around the edges of the closely-packed particles.

Due to the close-packed arrangement of the particles, separators 8 formed in this way are able to have a significantly reduced thickness. Despite this, the separator 8 is strong and flexible and can ensure electrical separation between two electrodes 4, 6. Due to its robustness to puncture, the “close-packed” separator 8, is able to resist puncture by dendrite deposits that may grow on an electrode 4, 6 during use.

An example material which is suitable for forming a “close-packed” separator 8 is silica, in particular silica nanoparticles which are cheap and easily obtained, and which are also advantageously chemically inert with respect to electrodes 4, 6 and electrolyte 10. The skilled person appreciates that other similar materials are suitable such as inert inorganic particles including Al₂O₃ and TiO₂.

To provide, such an ink with suitable particles to form a “close-packed” separator, the following example steps may be taken, as depicted in FIG. 7.

In the first step 402, particles of a separator-forming material having a suitable morphology to form a close-packed array are provided. Thereafter, in step 404, the electrolyte 10 is provided and in step 406 the solvent is provided. In the following step 408, the electrolyte 10 is added to, and dissolved in, the solvent. Finally, in step 410, the particles of the separator-forming material are added to the solvent. The skilled person appreciates, however, that these steps could be done in any order.

Referring once again to FIG. 2, the second step 104 of the process will now be described.

In the second step 104 the medium is provided. The medium being the component on which the ink is to be applied and the separator 8 is to be printed.

As explained above, the medium can be any suitable substrate 20. The substrate 20 may, for example, be an electronically insulating or conductive material; for example a sheet of a fabric, a polymer, a glass, a paper, a metal, or a ceramic. After the separator 8 is printed and fully formed on the substrate 20, it could optionally be removed therefrom for use within an electrochemical cell manufactured in a separate process.

Alternatively, the medium could be another component of an electrochemical cell 2 (such as a first or second electrode 4, 6 of the electrochemical cell 2). Indeed, this other component may itself have been printed and could also include electronic circuits. This will be described in more detail below.

In the third step 106 of the process depicted in FIG. 2 separator 8 is printed.

In step 106, one of the above-described inks is applied to the medium in a printing process. To this end, any suitable printing process may be used such as screen-printing, stencilling, flexography, gravure, and off-set and ink-jet printing. The ink is preferably applied using a bar coater. Such printing processes allow thin layers of ink to be applied to the medium so that thin separators 8 may be formed.

In the final step 108 of the process shown in FIG. 2, the separator 8 is formed on the medium out of the particles of separator-forming substance in the printed layer of ink.

To form the separator 8 from the printed layer of ink, the ink can be dried, for example, using a heater or a laser. In doing so, the solvent or any liquid or gel in the ink may be evaporated such that the particles of separator-forming substance are left on the medium and form the separator 8.

As mentioned above, the ink may comprise a second separator-forming substance, such as polymeric binder. In this case, the separator 8 formed on the medium comprises both particles of the separator-forming substance and the second separator-forming substance, in this case a polymeric binder.

In cases where the ink comprises a polymeric binder it may be particularly suitable to cure the ink in order to form the separator 8 on the medium. Use of such a curing process may replace of supplement any drying of the ink.

In cases where the morphology of the particles of separator-forming substance in the ink support the formation of a close-packed array, the ink is typically be almost completely removed from the formed separator 8, for example, by using a heater or a laser. However, some of the ink remains within the structure of the separator 8, coating the particles, to facilitate the retention and movement, in use, of the electrolytic ions.

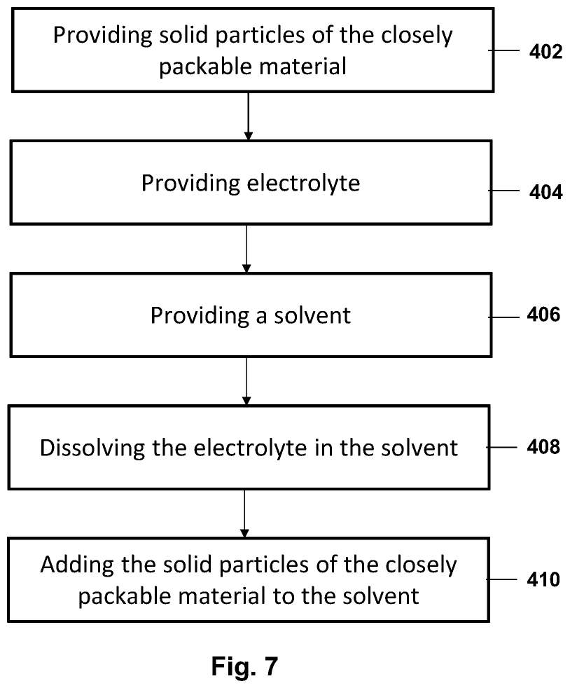

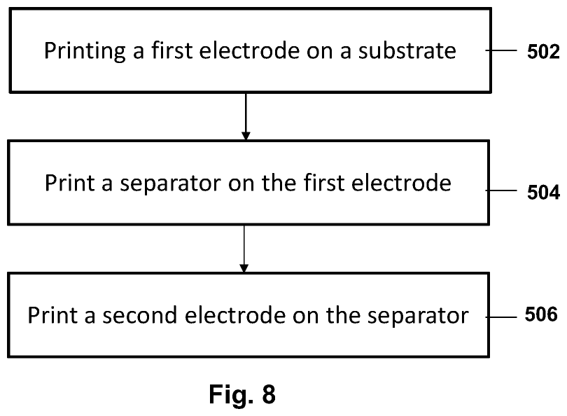

With reference now to FIG. 8, an example process for manufacturing an electrochemical cell 2 including a separator 8 will be described.

In a first step 502, a first electrode 4 is printed on a substrate 20. Thereafter, in step 504, a separator 8 is then printed on the first electrode 4 in accordance with any of the process for printing a separator 8 as described above. In this example, the medium referred to in the description of the ink formulations above takes the form of the printed first electrode 4. In the final step 506, a second electrode 6 is printed on the separator 8 to form the electrochemical cell 2. If desired, the substrate 20 could be removed from the electrochemical cell. Alternatively, the electrochemical cell 2 may be printed onto the substrate intended for use in the final product such as clothing, a wearable device or any other product suitable for use with a printed electrochemical cell.

By printing each of part of the electrochemical cell 2 one on top of the other, this method can produce an entire electrochemical cell 2 using a single printing device. This allows cells to be printed reel-to-reel using conventional printing techniques. Alternatively, the separate layers of the electrochemical cell 2 may be printed by separate printing devices.

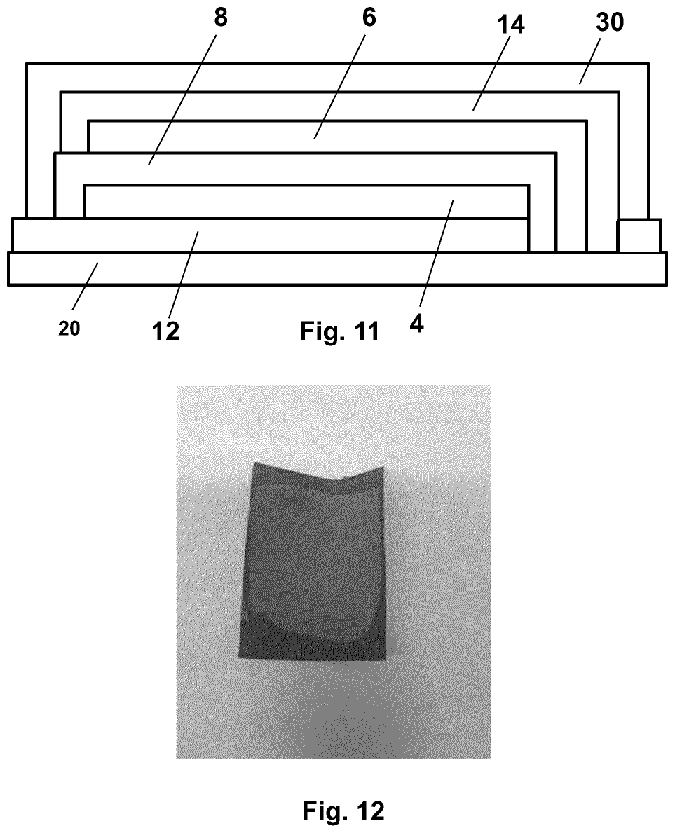

In an alternative example, an electrochemical cell 2 with current collectors 12, 14 may be printed. In this case, the first step in the process comprises printing a first current collector 12 on a substrate 20, and then printing a first electrode 4 on the first current collector 12. Similarly, the final step in the process comprises printing a second current collector 14 on the second electrode 6. Such a printed electrochemical cell 2 with first and second current collectors 12, 14 is shown in FIG. 11, and a photograph of one such electrochemical cell 2 is shown in FIG. 12.

Each of the above-described processes for printing an electrochemical cell 2 may also include a step of printing a protective cover 30 over the first current collector 12, the first electrode 4, the separator 8, the second electrode 6 and/or the second current collector 14. For example, for the electrochemical cell 2 having current collectors 12, 14 shown in FIG. 11, the protective cover 30 is printed directly over the first and second current collectors 12, 14 and the separator 8. The protective cover 30 is preferably electrically insulating and serves to seal the electrical components of the electrochemical cell 2 with in the protective cover 30 while allowing access to the current collectors 12, 14 and/or the electrodes 4, 6 for electrical connection.

The benefit of the above described methods is that a complete electrochemical cell 2 can be printed onto a single substrate 20 without interruption or the need to move the substrate 20 between printing devices.

As an alternative to printing the first and/or second electrodes 4, 6, they could instead be provided and applied to the substrate 20 and/or the separator 8 using any suitable processes. Moreover, instead of printing the separator 8 on the first electrode 4, the separator 8 may be printed on a separate substrate in accordance with any of the processes outlined above. In this case, the separator 8 is removed from the substrate that it was printed on and arranged between first and second electrodes 4, 6. An electrochemical cell 2 formed in such a way may therefore be described as a partially printed electrochemical cell. Likewise, the current collectors 12, 14 could be provided and applied to the electrodes 4, 6 as a last step of the cell manufacture process. It will be understood that the first current collector 12 could itself be the substrate 20 upon which the first electrode 4 is printed. The skilled person will appreciates that many variations are possible.

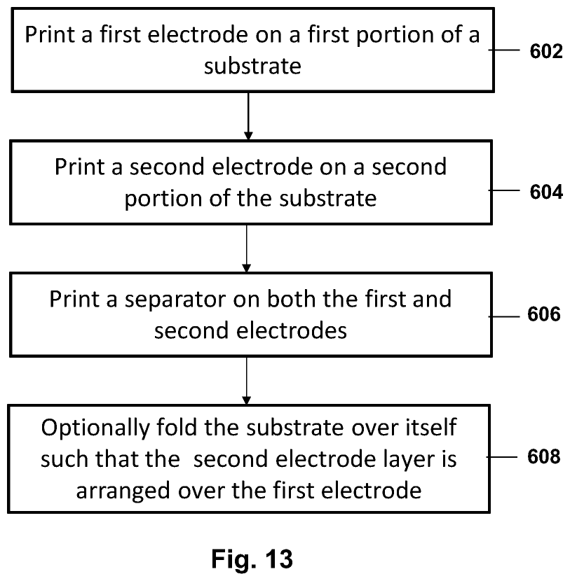

An alternative example process for printing an electrochemical cell 2 will now be described with reference to FIG. 13 which shows an embodiment of a printed complete electrochemical cell 2 (in this case without current collectors 12, 14).

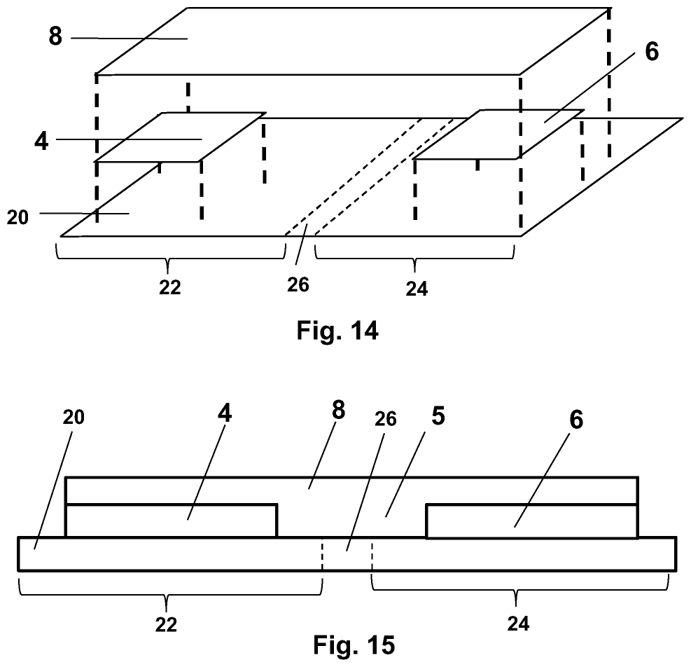

In this example, the substrate 20 comprises first, second and third portions 22, 24, 26, as depicted in FIGS. 14 and 15. The first and second portions 22, 24 are preferably close to, but not bordering, each other. A third portion 26 extends between the first and second portions 22, 24 so that the first and second portions 22, 24 are arranged away from one another on either side of the third portion. As shown in FIGS. 14 and 15, each of the first and second portions 22, 24 can take up one of two ends of the substrate 20, while the third portion 26 can include the middle section extending between the two ends. The skilled person however appreciates other suitable and appropriate arrangements are possible.

In the first step 602 of this process, a first electrode 4 is printed on the first portion 22 of the substrate 20 and in the second step 604 the second electrode 6 is printed on the second portion 24 of the substrate 20. The skilled person appreciates that these electrodes 4, 6 could be printed in any order or even simultaneously. Because of the arrangement of the first and second portion 22, 24, an gap 5 is formed between the first and second electrodes 4, 6, thereby preventing contact of the first and second electrodes 4, 6 in use.

In the third step 606, and as shown in FIGS. 14 and 15, a separator 8 is printed over both the first and second electrodes 4, 6 and over the third portion 26 of the substrate 20. Therefore, in this example embodiment, the medium referred to in the above-described printing processes takes the form of both the printed first and second electrodes 4, 6, and the third portion 26 of the substrate 20. In this example, a single separator 8 forms continuous layer.

The fourth step 606 comprises folding the substrate 20 over itself such that the second electrode 6 is arranged over the first electrode 4. In this way, the electrochemical cell 2 takes the form of a pouch. If desired, the substrate 20 could be removed from the electrochemical cell.

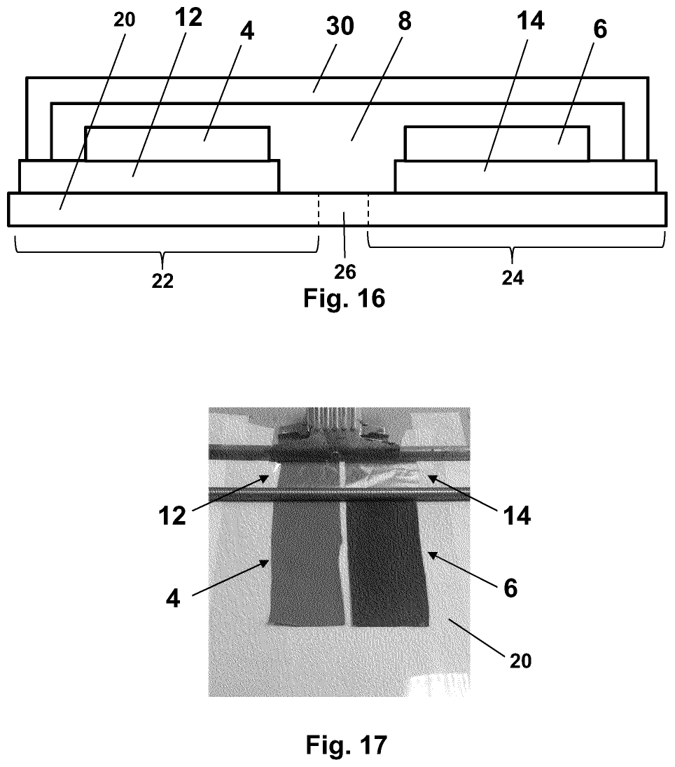

If current collectors 12, 14 are also to be provided, the process may also include printing a first current collector 12 on the first portion 22 of the substrate 20 and printing a first electrode 4 on the first current collector 12. Additionally or alternatively, the process may include printing a second current collector 14 on the second portion 24 of the substrate 20 and printing a second electrode 6 on the second current collector 14. The skilled person appreciates that these steps may be undertaken in any appropriate order. A printed electrochemical cell 2 with first and second current collectors 12, 14 is shown in FIG. 16, and a photograph of one such electrochemical cell 2 being printed is shown in FIG. 17.

The above-described processes may include the additional step of printing a protective cover over the first current collector 12, the first electrode 4, the separator 8, the second electrode 6 and/or the second current collector 14. For example, for the electrochemical cell 2 with current collectors 12, 14 shown in FIG. 16, the protective cover 30 may be printed directly over the first and second current collectors 12, 14 and the separator 8. The protective cover 30 is preferably electrically insulating and serves to seal the electrical components of the electrochemical cell 2, while allowing access to the current collectors 12, 14 and/or the electrodes 4, 6 for electrical connection.

In an alternative example, the first and/or second electrodes 4, 6 or the first and/second current collectors 12, 14, may be provided pre-formed and applied to the substrate 20 (or current collectors 12, 14) using any suitable processes. When first and/or second current collectors 12, 14 are provided they may constitute the substrate 20 upon which the electrochemical cell 2 is printed. Moreover, instead of printing the separator 8 on the first and second electrodes 4, 6, the separator 8 may be printed on a separate substrate and then removed from the substrate and arranged over the first and second electrodes 4, 6. In such an embodiment, the electrochemical cell 2 may therefore be described as partially printed. Likewise, the current collectors 12, 14 may be provided pre-formed and applied to the substrate 20 using any suitable process.

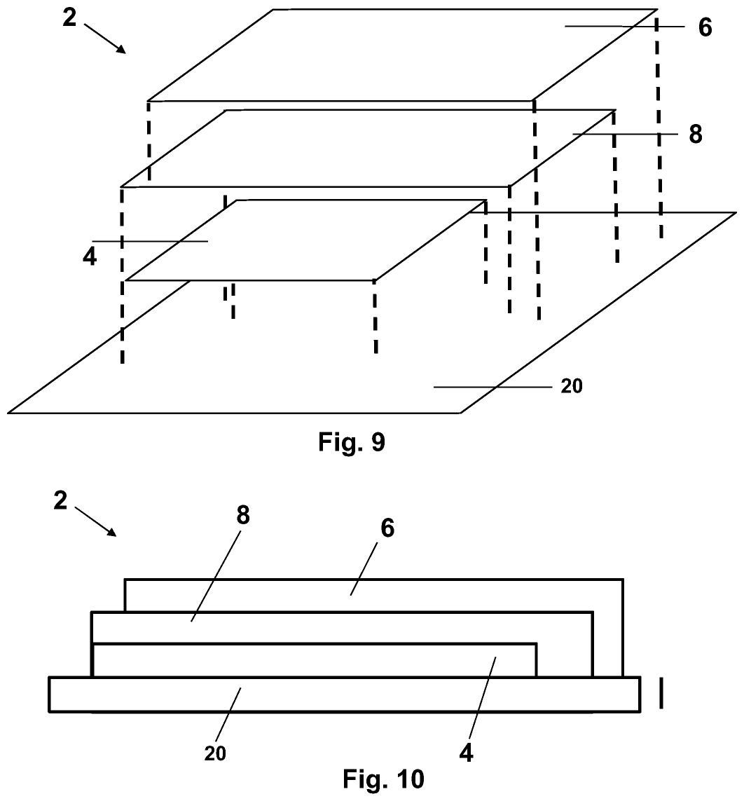

It should be noted, in reference to FIGS. 9 to 12 and 14 to 17, that regardless of how the different components are arranged, it is necessary that each of the first and second electrodes 4, 6, or each of the first and second current collectors 12, 14 (if used), remain connectable to an electrical device (not shown). So long as this is ensured, the components of the electrochemical cell 2 can be stacked and overlaid in any suitable way. Indeed, the skilled person appreciates the many possible variants of this.

In cases where the electrochemical cell 2 does not include current collectors 12, 14, it may be desirable to print the components such that the separator 8 is not exposed to the outside at all in the formed electrochemical cell 2. Likewise, if the electrochemical cell 2 is to include current collectors 12, 14, it may be desirable to print the components of the electrochemical cell 2 such that the separator 8 and the first and second electrodes 4, 6 are not exposed to the outside at all in the formed electrochemical cell 2.

To print any of the electrodes 4, 6, the current collectors 12, 14 or the protective covers 30 described above a suitable ink must be provided. Thereafter, the ink is applied to a substrate or to another component of the electrochemical cell 2 using any suitable printing process such as screen-printing, stencilling, flexography, gravure, and off-set and ink-jet printing. Finally, the electrode, the current collector or the protective cover 30 is then formed from the applied ink by e.g. drying or curing the ink as appropriate.

A positive electrode ink may comprise manganese dioxide particles, a carbonaceous material, an alcohol-based polymeric binder and an alcohol solvent in which the other components may be dispersed. In other embodiment, the particles of manganese dioxide particles could instead be NiOOH, other metal hydrides, Ag₂O. Meanwhile, the negative electrode ink may comprise zinc particles, an alcohol-based polymeric binder and an alcohol solvent in which the other components may be dispersed. In other embodiments, the zinc particles could instead be any easily reducing metal, such as lead. Each of the positive and negative electrode inks can be exposed to a post-printing treatment to improve its functionality, which can include laser sintering, heat sintering, and intermittent pulsed light sintering.

A current collector ink may comprise at least one conductive active material such as carbon, copper and silver, a polymeric binder and a solvent in which the other components may be dispersed. Instead of being printed, the current collectors 12, 14 can be provided as a foil. This ink may then be dried or cured by exposure to heat or light.

A protective cover ink may comprise impermeable polymers, ceramics and/or metal oxides. The protective cover 30 may also be made up of a plurality of protective cover layers, each being printed from an ink comprising impermeable polymers, ceramics and/or metal oxides and/or made from such materials.

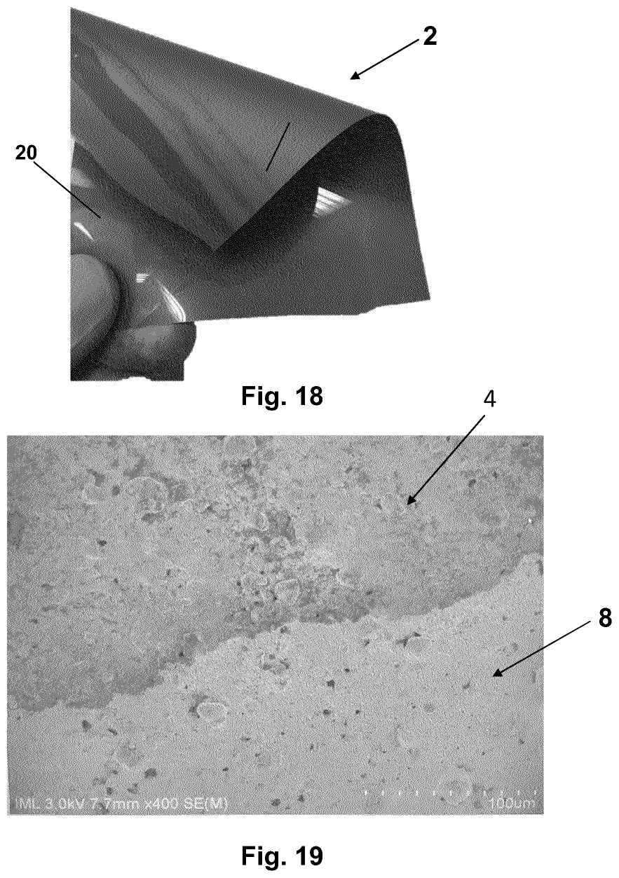

The electrochemical cell 2 of FIG. 18 is an example of an electrochemical cell 2 that has been fully printed on a substrate 20 and that includes a separator 8 that has been printed in accordance with one of the process described above. As can be seen well in FIG. 18, the electrochemical cell 2 is flexible and hence well suited for a variety of applications.

FIG. 19 is an image produced by a scanning electron microscope (SEM) of MOF particles printed from an ink onto a positive electrode 4 that has been printed from an ink comprising manganese dioxide.

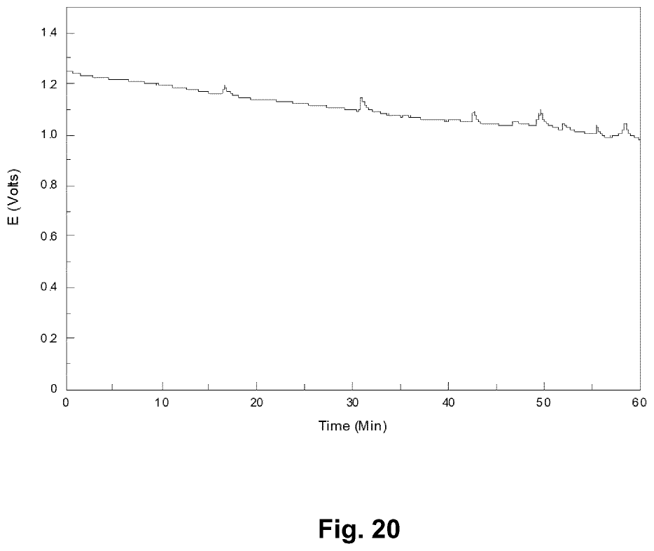

FIG. 20 shows a 1 μA discharge curve of one such fully printed electrochemical cell 2.

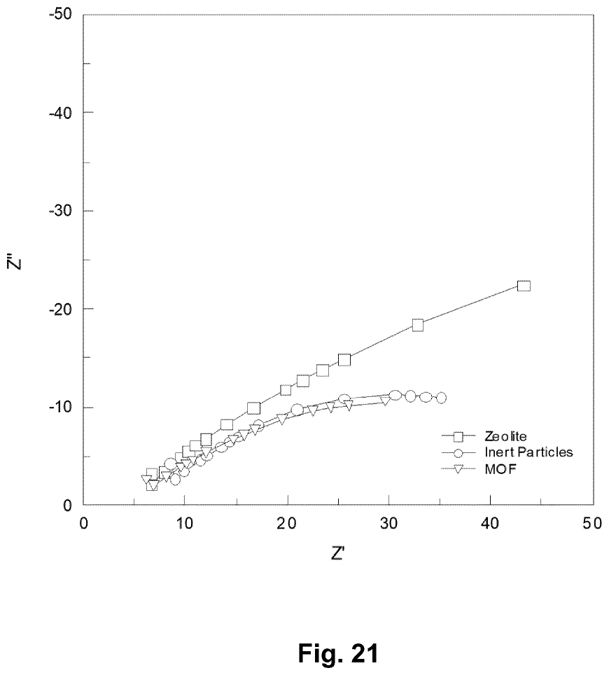

FIG. 21 shows an electrochemical impedance spectra applying a 10 mV AC sinusoidal voltage at frequencies between 10⁵ and 10⁻¹ Hz, for three printed cells containing three differing electrolytes.

As stated above, the process of the invention can be used to produce a high volume and high throughput of thin and flexible electrochemical cells 2 that can be used to provide energy storage for a number of applications including least the following.

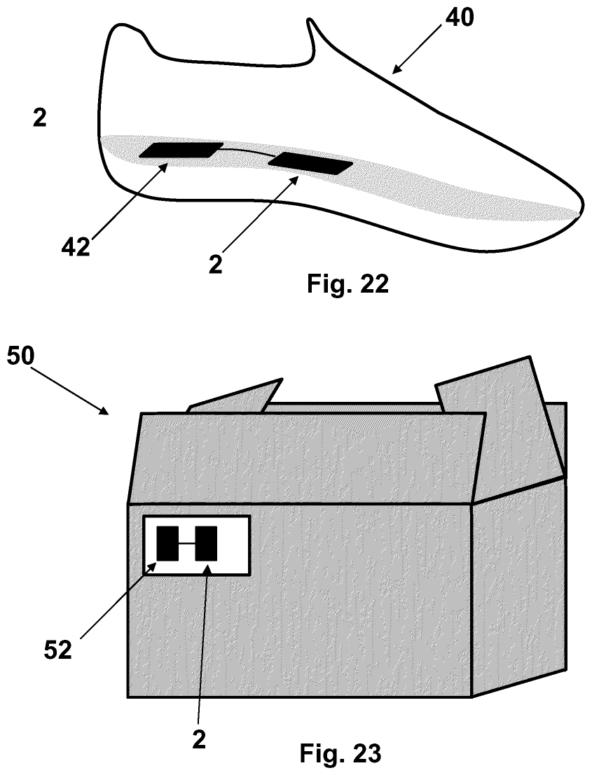

Such an electrochemical cell 2 can be used to store and supply energy from an energy harvesting device. As shown in FIG. 22, the electrochemical cell 2 is used to store and supply energy from a piezoelectric device 42 in article of footwear 2. To this end, the electrochemical cell 2 and the piezoelectric device 42 are installed in, and preferably within a sole of, the 40 footwear, and are coupled together using a conventional means.

Likewise, the electrochemical cell 2 can be used to provide power for smart packaging, As shown in FIG. 23, an article of packaging 50 is provided with a smart device 52 and such an electrochemical cell 2 configured to provide power to said smart device 52. In one embodiment, the smart device 52 takes the form of an environmental logging device, i.e. a device configured to measure information about the environment (e.g. temperature) of (e.g. the inside) of the packaging 50. Additionally or the alternatively, the smart device 52 may take the form of a radio-frequency identification device.

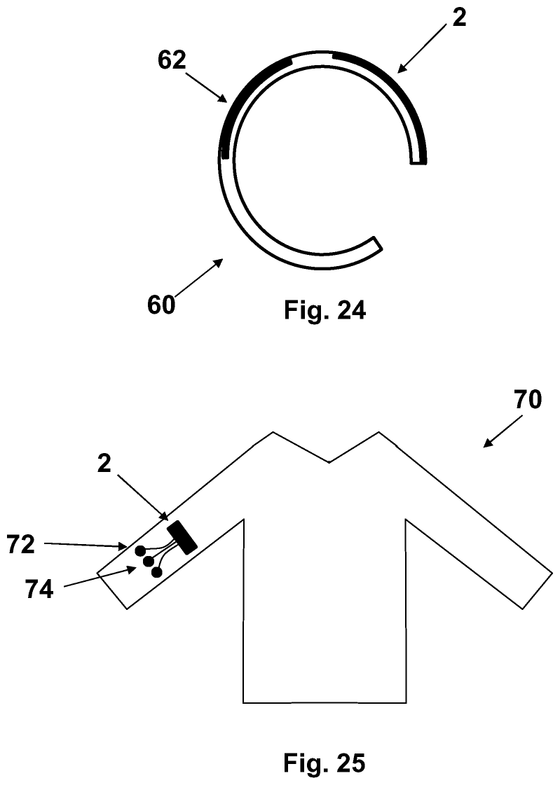

The electrochemical cell 2 can be used to power medical devices. As shown in FIG. 24, a wristband 60 comprises a sensor 62 configured to acquire data from a user (not shown) (such as the temperature or heart rate of the user) and an electrochemical cell 2 coupled to, and configured to provide power to, the sensor 62.

The electrochemical cell 2 can also be integrated into wearable electronics. As shown in FIG. 25, an article of clothing 70 comprises a sensor 72 configured to acquire data from a user (such as the temperature or heart rate of the user) and/or a light 74, and an electrochemical cell 2 coupled to, and configured to provide power to, the sensor 72 and/or a light 74.

Additionally, such an electrochemical cell 2 can be integrated into smartcards to power devices such as microchips, and also into novelty consumer technology (such as functional greetings cards) for similar reasons.

### Example

An example of printing an electrochemical cell is given below.

In a first step the following positive electrode ink is made up. Carboxymethylcellulose (CMC) and styrene-butadiene rubber (SBR) in a mass ratio of 1:1 are dispersed in distilled water. Carbon black (CB) and manganese dioxide (MnO₂) particles are then added to the solution which is mixed until homogenous. The mixture is finally subjected to ultrasonic waves to ensure homogeneity. The final mixture contains MnO₂ to CB to CMC to SBR in a 85:5:5:5 mass ratio. The solid particles comprises less than 20 volume % of the mixture.

The following negative electrode ink is then made up. Carboxymethylcellulose (CMC) and styrene-butadiene rubber (SBR) in a mass ratio of 1:1 are dispersed in distilled water. Zinc particles are then added to the solution which is mixed until homogenous. The mixture is finally subjected to ultrasonic waves to ensure homogeneity. The final mixture contains Zn to CMC to SBR in a 90:5:5 mass ratio. The solid particles comprises less than 20 volume % of the mixture.

The following separator ink is then made up. Polyacrylic acid (PAA) is dissolved in distilled water. Potassium hydroxide is then dissolved in the solution to form a 10M solution. A water-resistant MOF is then added to the solution, which is then mixed until homogenous. The mixture is then subjected to ultrasonic waves to ensure homogeneity. The final mixture contains MOF to PAA in a 99:1 mass ratio. The solid particles comprises less than 20 volume % of the mixture.

A foil of nickel is provided, which serves as the first current collector. An adhesive copper layer is provided, which serves as the second current collector.

The positive electrode functional ink is applied to a layer of the nickel foil using a wire bare coating method. A layer with a thickness less than 5 microns is deposited. The layer is then dried in an oven at a temperature 80° C. until the positive electrode is formed. The separator ink is then applied to the fully cover the positive electrode. A layer with a thickness less than microns is deposited. The layer is then dried in an oven at a temperature 80° C. to form the separator. The negative electrode ink is then deposited on top of the separator layer. It is important to prevent the negative electrode ink from contacting the positive electrode layer and the nickel foil. A layer with a thickness less than 5 microns is deposited. The layer is then dried in an oven at a temperature 80° C. until the negative electrode is formed. Finally, a layer of the adhesive copper is applied on top of the negative electrode. It is again important to prevent the adhesive copper from contacting the positive electrode layer and the nickel foil.

Many variations of the invention are possible without departing from the spirit and scope of the invention as set out in the claims.

1. A method of printing a separator for an electrochemical cell, the method comprising:
providing an ink comprising particles of a separator-forming substance suspended therein;
providing a medium;
applying a layer of the ink to the medium in a printing process; and
forming a separator from the separator-forming substance in the layer of ink.

2. The method as claimed in claim 1, wherein the ink comprises an electrolyte and wherein the separator-forming substance forms a separator that hosts at least some of the electrolyte.

3. The method as claimed in claim 1, wherein the step of forming the separator comprises drying or curing the ink.

4. The method as claimed in claim 1, wherein the separator-forming substance is an ionic conductor material.

5. The method as claimed in claim 4, wherein the ionic conductor material is a nano-porous material.

6. The method as claimed in claim 5, wherein the nano-porous material is a zeolite or an organic framework material such as a metal organic framework or a covalent organic framework.

7. The method as claimed in claim 5, wherein the separator is at least partially impregnated with ions provided from the electrolyte when formed.

8. The method as claimed in claim 7, wherein the step of providing an ink comprises the steps of:
providing particles of the nano-porous material;
providing the electrolyte;
providing a solvent;
dissolving the electrolyte in the solvent; and
adding the particles of the nano-porous material to the solvent to form the ink.

9. The method as claimed in claim 8, wherein the ink comprises a second separator-forming substance in the form of polymeric binder, and wherein the separator is formed from the separator-forming substance and the second separator-forming substance.

10. The method as claimed in claim 9, wherein the step of providing an ink comprises the step of adding polymeric binder to the solvent, and wherein the step of forming a separator optionally comprises curing the ink.

11. The method as claimed in claim 4, wherein the ionic conductor material is a solid ionic conductor, optionally lithium phosphorus oxynitride.

12. The method as claimed in claim 11, wherein the ionic conductor material is an inorganic lattice material, preferably a crystalline conductor.

13. The method as claimed in claim 12, wherein the inorganic lattice material is a perovskite material or a lithium superionic conductor material.

14. The method as claimed in claim 12, wherein the electrolyte comprises the inorganic lattice material.

15. The method as claimed in claim 11, wherein the step of providing an ink comprises the steps of:
providing particles of the solid ionic conductor;
providing a liquid or a gel; and
adding the particles of the solid ionic conductor to the liquid or gel to form the ink.

16. The method as claimed in claim 1, wherein the formed separator comprises a close-packed array of the particles of separator-forming substance.

17. The method as claimed in claim 16, wherein the particles of separator-forming material comprise a non-ionic conductor material.

18. The method as claimed in claim 17, wherein the step of providing the ink comprises the steps of:
providing particles of the non-ionic conductor material;
providing the electrolyte;
providing a solvent;
dissolving the electrolyte in the solvent to form an electrolytic solution; and
adding the particles of the non-ionic conductor material to the solvent to form the ink.

19. The method as claimed in claim 18, wherein the particles of separator-forming substance in the formed separator are at least partially coated with the electrolytic solution.

20. A method of forming an electrochemical cell, the method comprising:
providing a first electrode;
printing a separator on the first electrode in accordance with the method of claim 1 wherein the medium is the first electrode; and
providing a second electrode, wherein the separator is located between the first and second electrodes in the so formed electrochemical cell.

21. (canceled)

22. (canceled)

23. (canceled)

24. (canceled)

25. (canceled)

26. (canceled)

27. (canceled)

28. (canceled)

29. (canceled)

30. (canceled)
